(19) United States
(12) Patent Application Publication
(10) Pub. No.: US 2008/0120323 A1
(43) Pub. Date: May 22, 2008

(54) System and method for generating customized reports

(75) Inventors: Dharmendra Etwaru, Queens, NY (US); Dennis Rossi, Bellmore, NY (US); Jacob Friedman, New York, NY (US)

Correspondence Address: Daniel H. Golub, 1701 Market Street, Philadelphia, PA, 19103, US

(73) Assignee: Lehman Brothers Inc., New York, NY (US)

(21) Appl. No.: 11/601,435

(22) Filed: Nov. 17, 2006

(51) Int. Cl. G06F 17/30

(52) U.S. Cl. 707/102; 707/E17.044

(57) ABSTRACT

Customized report generation system and method. Data is retrieved from one or more repositories. The data is consolidated to form a data file. Configuration information from a template file is applied to the data file to produce a report file. Customized reports are generated based on the report file.

### FIELD OF THE INVENTION

The present invention relates to generating customized reports.

### BACKGROUND OF THE INVENTION

Many firms have a need to prepare periodic reports for their clients. This is particularly true in the financial services industry, e.g., where an investment firm is performing wealth management services for investors. Prior art systems allow for the generation of customized reports. However, such reports can only be generated on an ad hoc basis. Prior art systems also provide for generating high volumes of reports; however, such reports are not individualized for a given client.

### SUMMARY OF THE INVENTION

The present invention is directed to a system and method for generating customized reports. Data is retrieved from one or more repositories. The data is consolidated to form a data file. Configuration information from a template file is applied to the data file to produce a report file. One or more customized reports are generated based on the report file.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention.

In the drawings:

FIG. 1 is an exemplary mark-up language report;

FIG. 2A illustrates an exemplary schema for report data;

FIG. 2B illustrates an exemplary schema for style data;

FIG. 3 illustrates exemplary schemas for report data;

FIG. 4 is a flow diagram of a process of an exemplary embodiment of the present invention;

FIGS. 5A and 5B are pages of an exemplary report generated in accordance with the present invention;

FIG. 6 illustrates an overview of a preferred embodiment of the inventive process;

FIG. 7 illustrates an exemplary hierarchy for a business data file used in connection with an exemplary embodiment of the present invention;

FIG. 8 illustrates an exemplary hierarchy for a report template file used in connection with an exemplary embodiment of the present invention;

FIG. 9 provides an illustration of an embodiment of a data consolidator used in connection with an exemplary embodiment of the present invention;

FIG. 10 provides an illustration of an embodiment of a report assembler used in connection with an embodiment of the present invention; and

FIG. 11 is a flow chart illustrating a preferred embodiment of a method of the present invention.

### DETAILED DESCRIPTION OF THE PREFERRED EMBODIMENTS

Reference will now be made in detail to the preferred embodiments of the present invention, examples of which are illustrated in the accompanying drawings. The preferred embodiments are described herein with reference to reports generated by, e.g., an investment firm and its clients. However, the invention is equally applicable to any type of report that is to be generated on a high-volume basis and would provide benefit if customized, and is not limited to the particular embodiments described herein. Also, the present invention is described herein as using XML to define various vocabularies; however, other industry standard markup languages can be used within the scope of the present invention.

Large volumes of customized reports may be produced as a result of the systems and methods described herein. A report markup language is used, based upon XML in the preferred embodiment, to fully describe a report and all the elements that make up a report (e.g., different sections, and the components that comprise each section, down to the level of each individual element). This language is also used to describe the different ways in which a report can be structured and formatted. Specifying each element of a report in XML, with the ability to easily manipulate it with XSLT, results in a report structure that is extensible and flexible. Establishing a standard way of describing a report (including its structure, data, and styles) allows for the easy exchange of information between different systems, as long as each system understands and adheres to the report XSD schema. The reporting engine can accept data from any data provider, and data providers can export information to any downstream system, as a result of the standard created. Because this standard is based on XML in the preferred embodiment, the data can be easily transported and manipulated, and the structure can be easily checked and enforced.

In general, a business schema is developed which describes the raw business data. This schema drives the remainder of the process, through multiple steps of transformations of the business data, through to the actual rendering of reports. The transformations include, e.g., addition of styles, labels, data types etc. These transformations are achieved through the use of sub-schemas, which are all driven by the business schema and describe how to add attributes to elements in the business schema. Transforming the business data in this way is extendible to any number of transformations in view of the fact that the system described herein provides a platform and a vocabulary to insert data points.

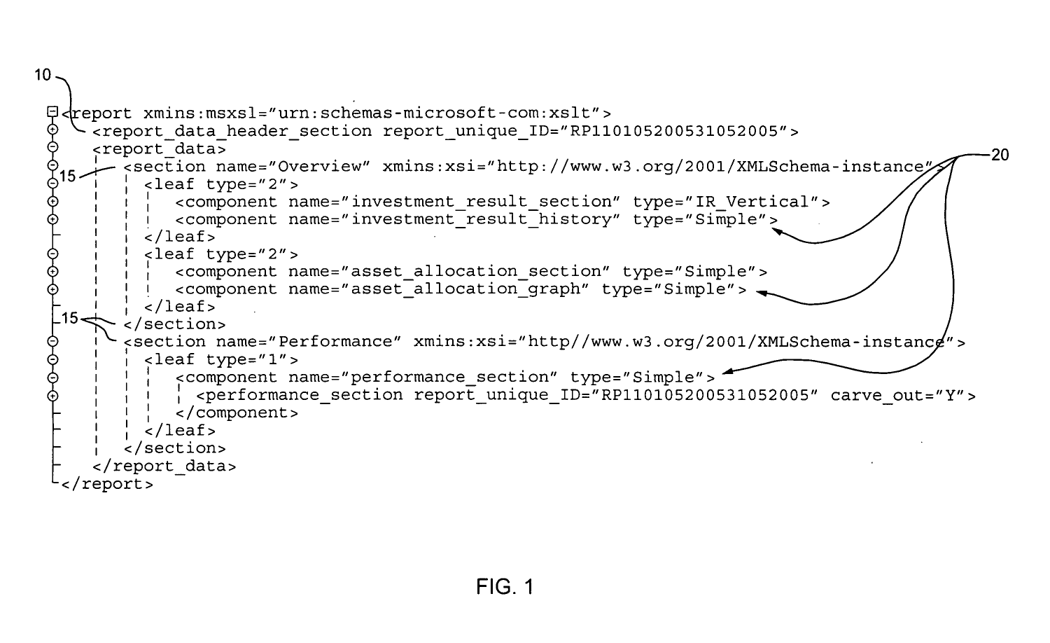

An exemplary report mark-up language is shown in FIG. 1. Report Header information 10, report sections 15 and report components 20 are shown.

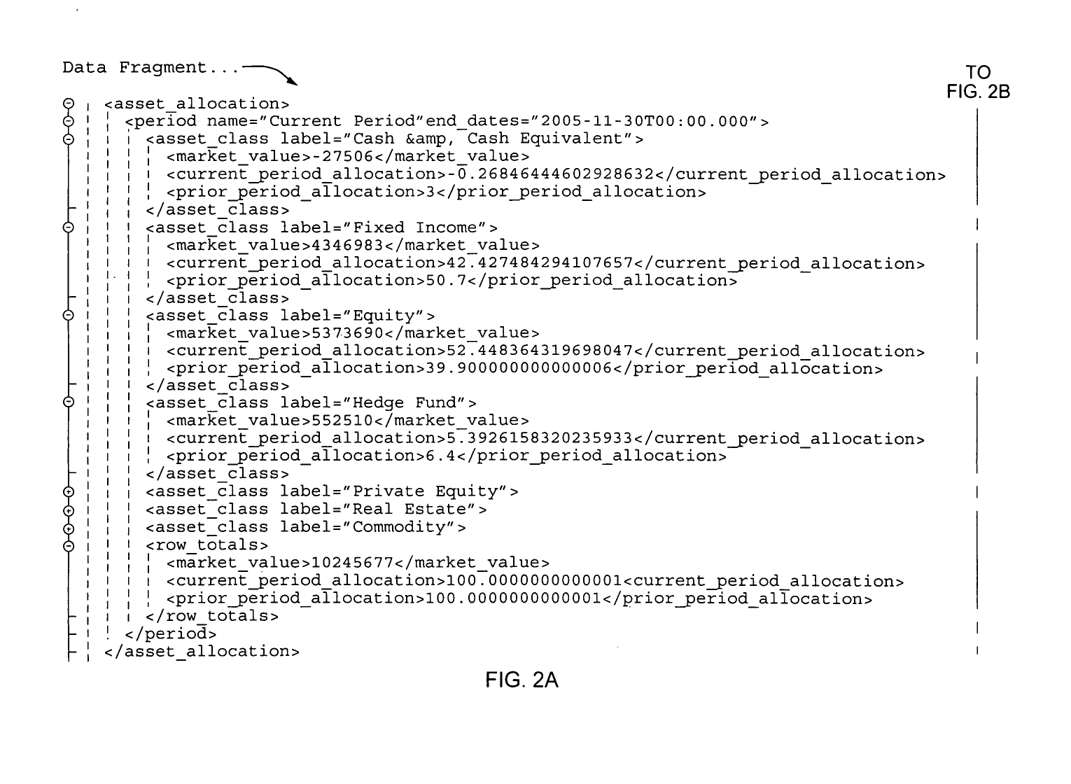

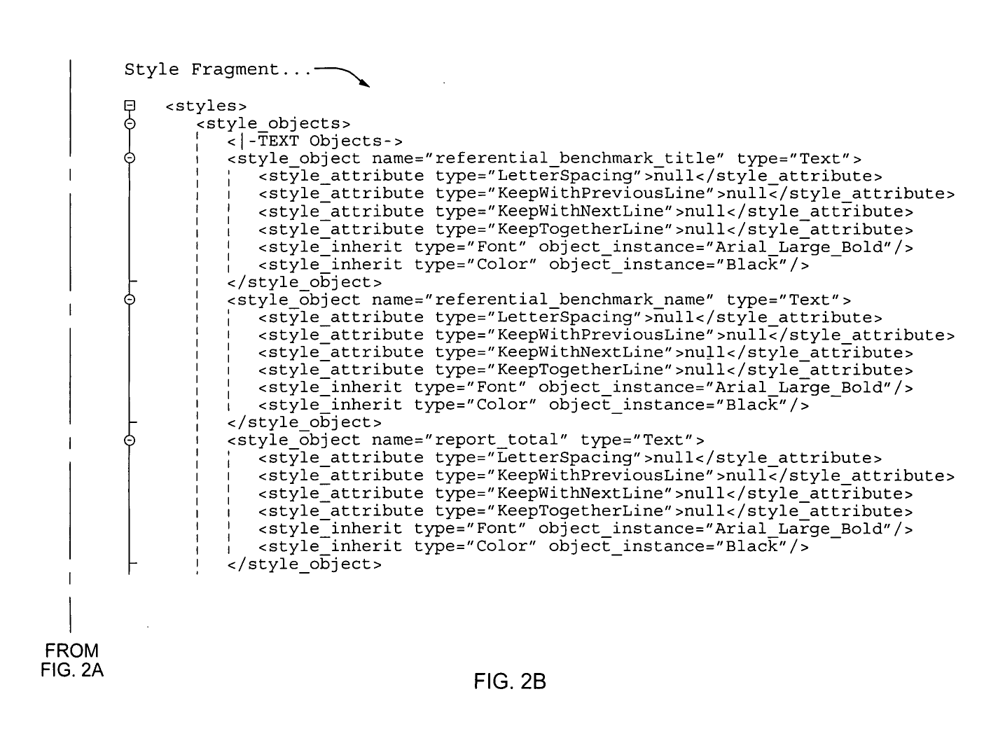

Reports that can be generated into a PDF can be considered to be made up of two main parts—the report data and the report configuration files. Each is defined by an XSD schema. FIG. 2A shows an exemplary XSD schema for report data and FIG. 2B shows an exemplary XSD schema for style (i.e., one component of configuration) data. Any data sent to and used by the system should be validated against the data schema. The schema for the report data accommodates and includes all the structures that are necessary to define a report, in the preferred embodiment. Report configurations files, defined and stored in XML in accordance with its own schema, define the way in which a report will look and feel. This includes, by way of example, the sections that are included in that report, the order of those sections, the formatting of the text, the formatting of numerical values, and the number and types of charts. The style XML file defines items such as font size, font family, font color, and numerical format, for each of the elements in a report, which also has its own schema. The layout XML file defines, in accordance with its own schema, items such as the sections that appear in a report, the order of each section, and the components that are available in each section. The configuration XML file defines the configuration changes that a client may specify for a particular report. These would include, by way of example, the inclusion of a graph and type of graph, the number of columns to show in a section, the specific periods to show in a table, and whether to show or not show a carve out section.

A report template is a set of customized report configuration files. A series of standard report templates are available to firm representatives, who have the option to choose from any of these templates from which to generate a report and, within each template, have the option to change some configuration settings.

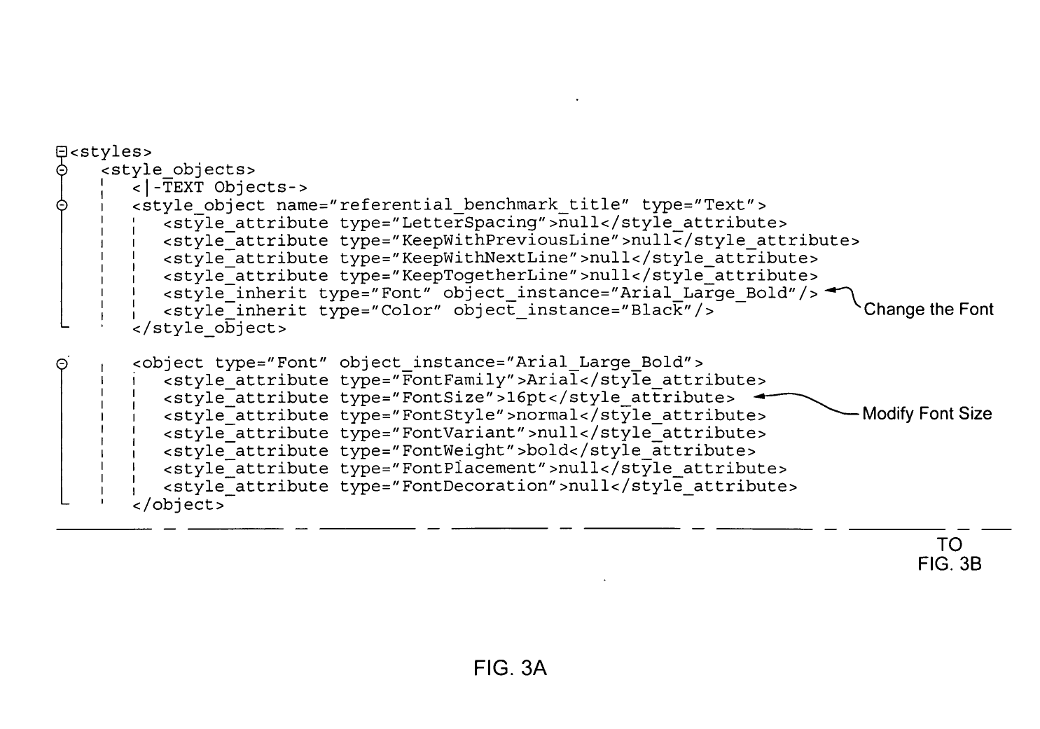

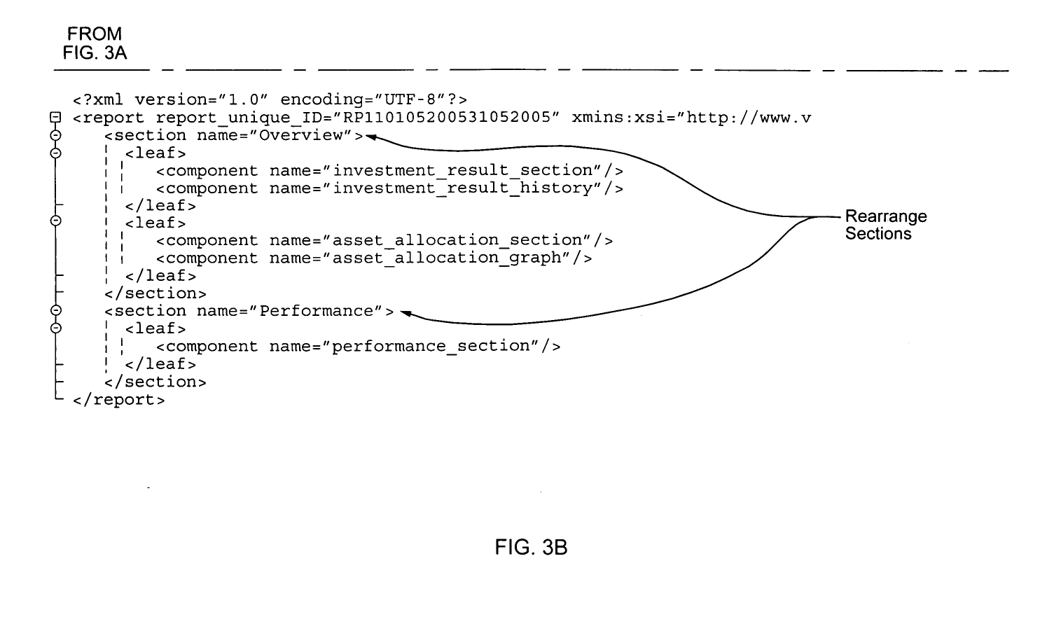

Given the report data and report configuration files are defined by an XSD schema, and stored as XML files, the entire report can be easily modified and extended. XML data can be, e.g., easily consumed by other applications using .Net or Java, transported through http, stored in databases such as UDB or SQL Server, and manipulated and transformed through XSLT or XSL-FO. In view of the fact that the elements of the report are defined, any individual element can be formatted, transformed, manipulated and modified. For example, with reference to FIG. 3, fonts can be changed, or the font size modified, and sections can be rearranged, simply by changing the XML file. Changes can be made at each stage of the report definition to provide complete flexibility. For example, labels can be changed for internationalization; data types can be changed for currency accommodation; and font sizes and colors can be edited on the fly for individual clients to accommodate the visibly impaired. An individual firm representative can specify changes to a particular template. A new template can be created and made available to all the firm representatives. The report schema itself can be changed to incorporate and include new and future reporting sections, or new configuration options.

In the preferred embodiment, in order for the system to accept data from existing firm systems, the data from those systems must be transformed into a format and a schema that conforms to the report data defined schema using a data adapter. For example, one type of adapter takes data from a spreadsheet and through a series of XSLT transformations, thereby creating an XML report data document that conforms to the defined schema. Different Data Adapters (i.e., unification platforms) can be used to accept data from other sources.

One embodiment of the system includes a data combiner, which accepts data feeds from multiple sources and combines them into an XML data document. In particular, the data for each section of a report may come from different data sources. The data combiner takes the data for each section, keeps track of the data, and combines it into one XML data document, fully compliant with the defined XML data schema.

An embodiment of the system may also include a consolidator/pre-renderer to prepare the report data XML for rendering, and apply the report configuration XML files to it. In particular, once the data file is ready, the configuration files for that report template are applied to the XML data file. This means that the data file is transformed by applying each of the configuration files to it (style, layout, configuration files). However, the data itself is not changed; instead, style, layout and configuration information is attached to each element. This prepares the report file for rendering into, e.g., PDF format.

A report validator may be included to provide a mechanism for report validation. Before the xml document is sent to be rendered into a PDF, the report validator may run a series of checks on that file, which can include business logic, intra-report, or options checks. The validator can cross-foot totals and portfolio positions, by way of example, for consistency checks. Thus, the validator can programmatically inspect the data for visible inconsistencies, which is typically a human function. The streamlining that is yielded by engaging the XSD schemas makes this possible in large volumes as the customizations are not an impediment given that they are compliant to the master (i.e., report schema).

When a data XML document ready to be rendered, a final transformation occurs. In particular, a template is applied to the data document. The data document is transformed by the template into an XSL-FO document, in the preferred embodiment. This template is designed to transform an XML document that conforms to a specific schema. This template is extensible and flexible to accommodate all current and future report sections, and all configuration options. In a final step, the XSL-FO document generated by the template and is transformed into a PDF document.

The system can be used to produce reports on an ad hoc or a batch basis. In a batch processing system, data is delivered in aggregated data files. An aggregated data file, or data file with data for multiple reports, is processed and rendered to produce reports in batch.

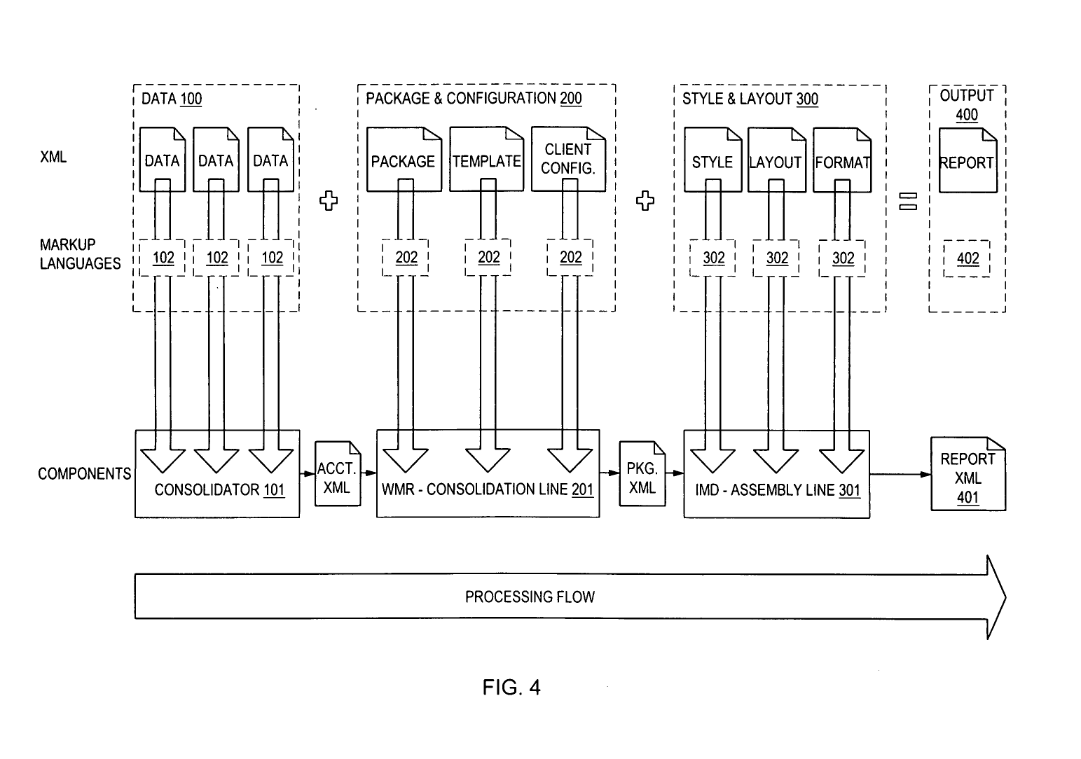

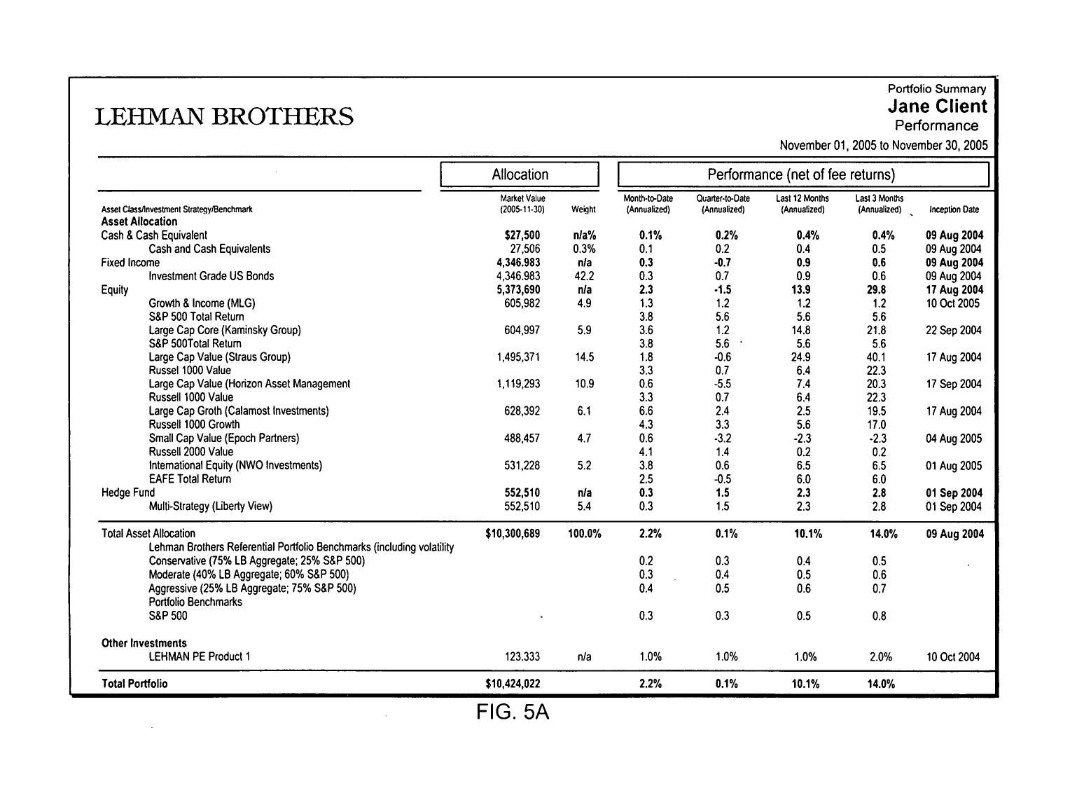

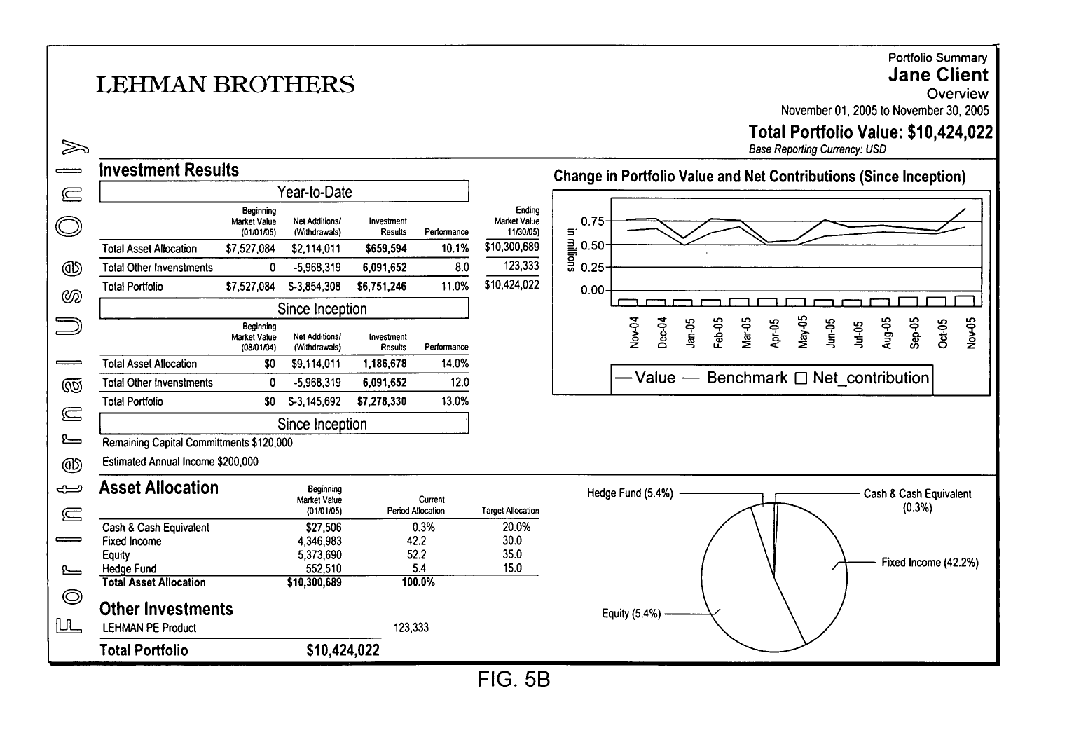

With reference to FIG. 4, a high level diagram of the process is shown. In step 101 of the process, data 100 retrieved from a number of different repositories is consolidated. Such data comprises raw business data associated with an account. An XML vocabulary file 102 is developed to describe each item of data and provide structure to the same. For example, FIGS. 5A and 5B show a portion of an exemplary report that may be generated using the invention. While this report shows the final result of the process, it is used for purposes of identifying the raw business data elements and values. With reference to FIG. 5B, “Asset Allocation” is a data element, which has four attributes associated with it (i.e., “Cash & Cash Equivalent”, “Fixed Income”, “Equity”, and “Hedge Fund”). Associated with these attributes are other attributes (e.g., “Market Value”) and numerical values (e.g., “27506”). It is important to note that numerical value “27506” is not associated with any formatting (e.g., dollar signs or commas) at this point in the process. It also bears noting that headings such as “Allocation” and “Performance (net of fee returns)”, as shown in FIG. 5A, are not part of the business data 100 and, instead, are part of the template inserted at a later stage of the process.

In step 201 of the process, package, template and client configuration information 200 are added. Broadly described, such information is that which is specific to each individual client/investor. For example, package information introduces the concept of an account and ownership of that account. Thus, this data may describe the number of recipients of the report, and the name and address of the account owner. Each client's package points to a particular template. A template is a collection of instances of mark-up language driver files that dictate how the report is to be laid out. For example, a template defines the sections that are in the report (e.g., a page) and which components are in those sections (e.g., with reference to FIG. 5B, “Investment Results”, “Asset Allocation”). The element names used in each driver file correspond to the elements in vocabulary files 102. Configuration information is also implemented at this step of the process, allowing for even further detailed customization. Such information comprises a more granular list of choices that result from a given template. Configuration information may include instructions, e.g., to show only two periods of performance history; include a larger font size; round off amounts to nearest dollar; and only include dollar signs with totals.

Thus, a client relationship manager who knows each of his clients, and the manner in which such clients would want their reports rendered, can specify the same in connection with generating reports. By defining those portions of the configuration that need to be exposed as customizable, creating a new driver file relating to such customization, and creating a process to insert it, generating large volumes of highly customized reports can be achieved.

At step 301 in the process, style/layout/format components 300 are added. Vocabularies 302 are defined to call out aspects of the data such as font, color, data format, and page breaks, by way of example. These components are interjected into an instance of the business data as it works its way through the assembly line.

At step 401 in the process, the output 400 is comprised of an XML document that contains the business data 100, the package and configuration information 200, and the style/layout/format components 300. The XML document is then rendered into an industry standard format (e.g., PDF), using commercially available software packages such as Assentis, as will be known to those skilled in the art.

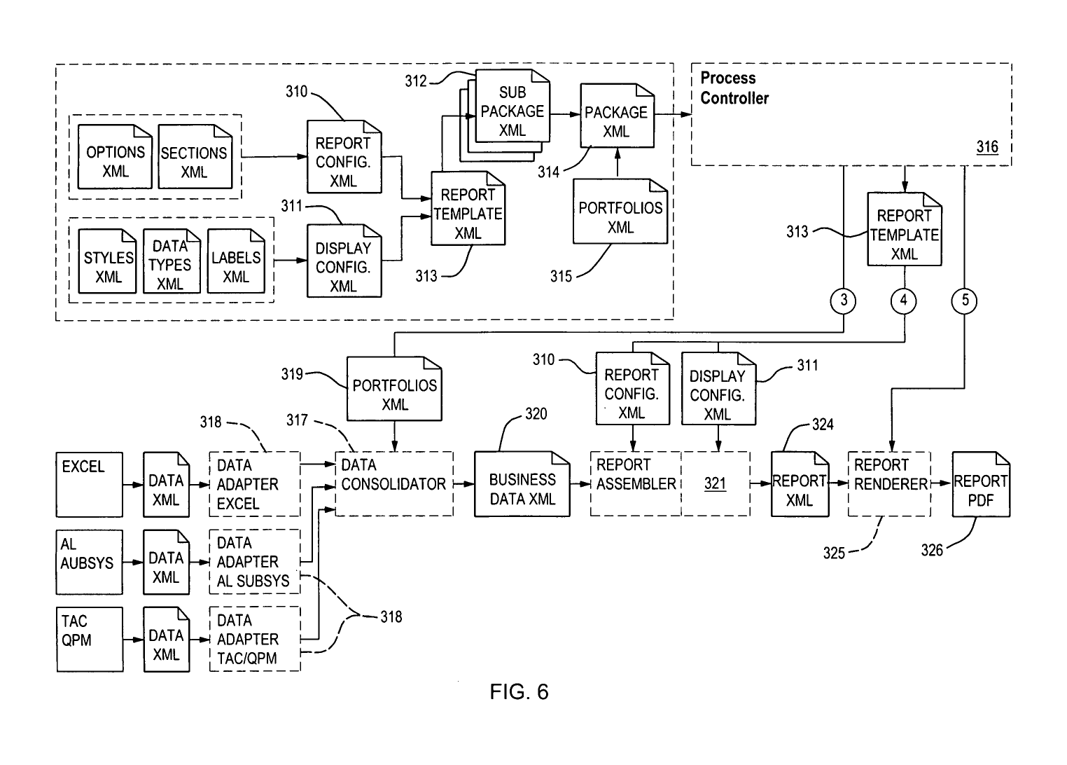

FIG. 6 provides a more detailed overview of a preferred embodiment of the inventive process. Report configuration file 310 contains Report Options and Section Structure information. Display configuration file 311 contains display configuration information such as styles, labels, and data types. A Report Template file 313 is associated with each Sub Package file 312 and is composed of report configuration and display configuration information. The Package 314 contains all the information necessary to generate a report and serves as the driver for the process. Each Package 314 may contain multiple Sub Packages files 312. Portfolios file 315 contains the list of accounts for each portfolio in a package. The Process Controller 316 retrieves the Package 314 and then calls each of the sub components, starting with the Data Consolidator 317, to create a report.

Data consolidator 317 retrieves data from one or more Adapters 318, using information from Portfolios file 319, and combines all the data into a Business Data file 320. Each adapter is configured to retrieve data from a given system. The Report Assembler 312 applies Report Configuration file 310 and Display Configuration file 311 information from the Report Template file 313 to the Business Data file 320 to produce a Report file 324. Report Renderer 325 uses the Report file 324 to produce a Report PDF 326.

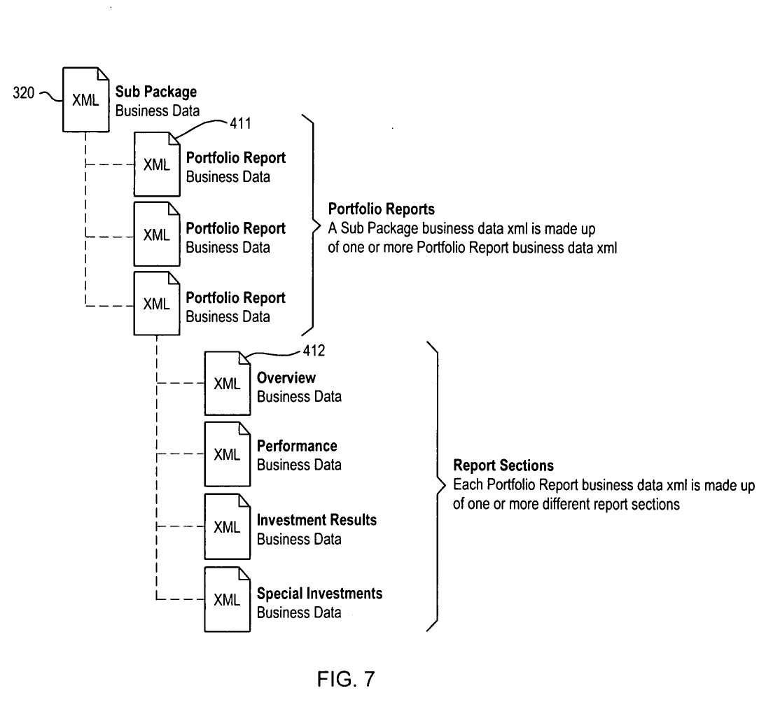

FIG. 7 illustrates an exemplary hierarchy for the Business Data file 320 of FIG. 6. A Business Data file 320 is the unit at which reports are aggregated and delivered to clients. A Business data file 320 is comprised of one or more Portfolio Report business data files 411 as shown in Package 314 and Portfolios file 315 of FIG. 6. Each Portfolio Report business data file is comprised of one or more different Report Sections 412 (e.g., Overview, Performance, Investment Results and Special Investments).

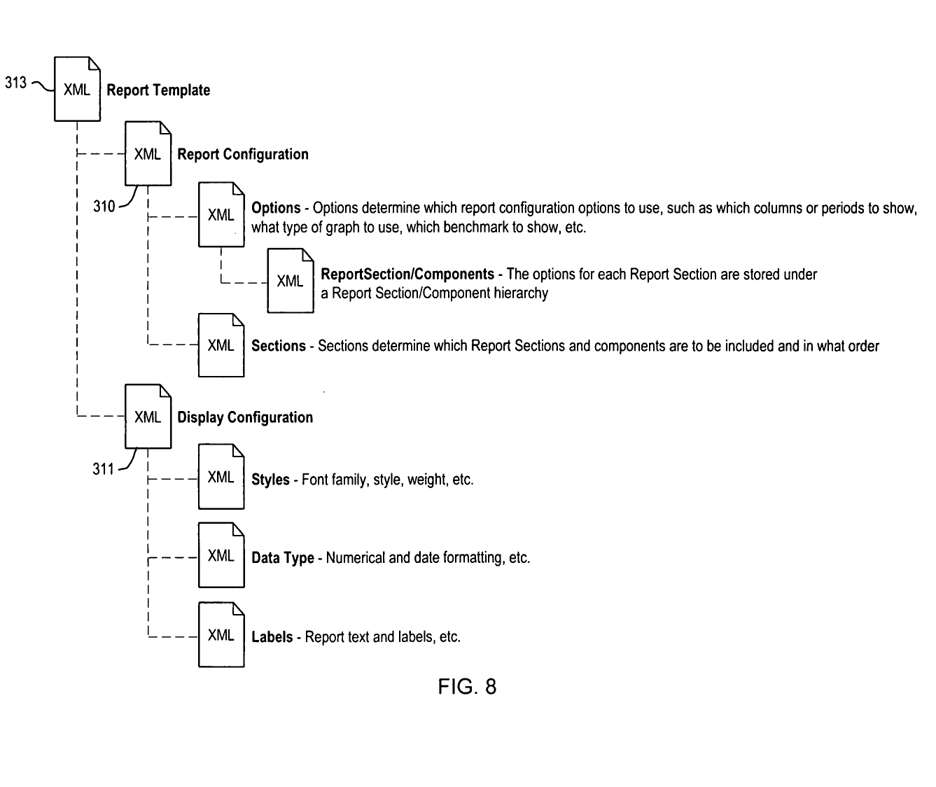

FIG. 8 illustrates an exemplary hierarchy for the Report Template file 313 of FIG. 6. A Report Template file 313 contains the information necessary to customize a Portfolio Report as shown in Package 314 and Portfolios file 315 of FIG. 6. It includes Report Configuration file 310 and Display Configuration file 311. Report Configuration file 310 includes the report option and structure information. Options determine which report configuration options to use, such as which columns or periods to show, what type of graph to use, and which benchmark to show, by way of example. The options for each report section are stored in accordance with a report section/component hierarchy. Sections determine which report sections and components are to be included and in what order. Display Configuration file 311 contains display and “look and feel” information, such as styles, data types, and labels, by way of example.

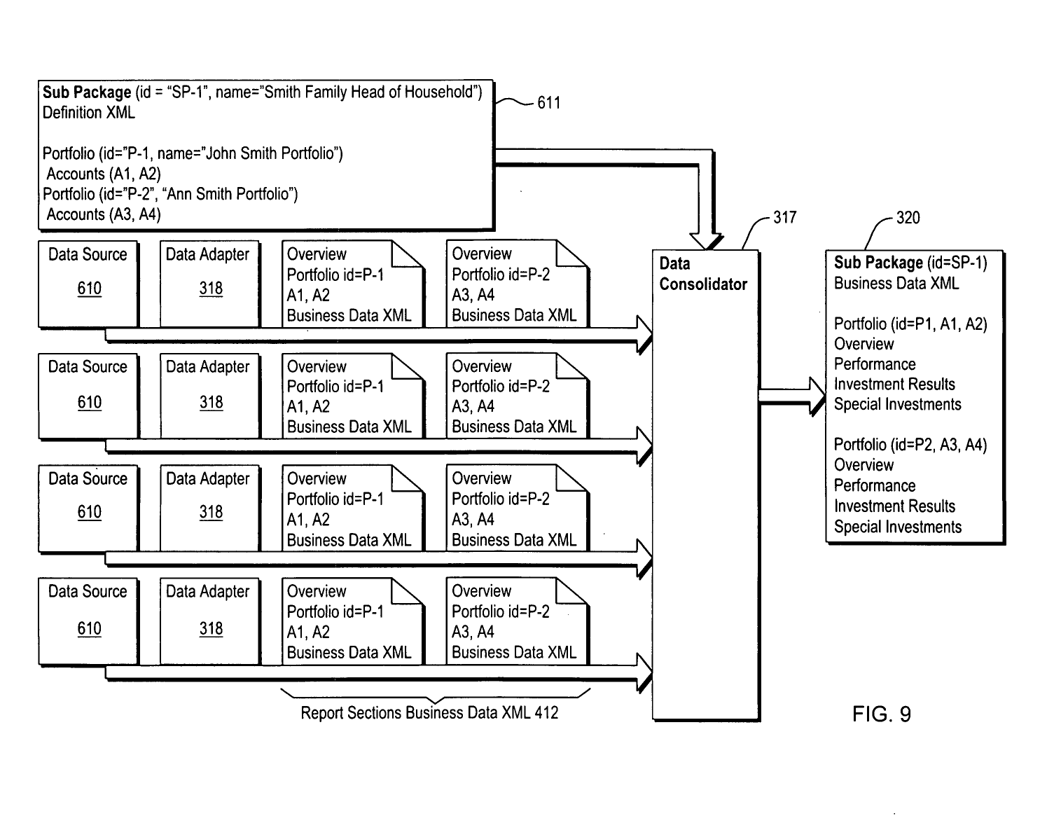

FIG. 9 provides a more detailed illustration of a preferred embodiment of the Data Consolidator 317 of FIG. 6. Sub Package Definition file 611, as shown by Sub Packages Files 312 of FIG. 6, is the driver file used by the Data Consolidator 317. It contains all the information necessary for the Data Consolidator 317 to retrieve data from different Data Adapters 318 and combine them into a Sub Package Business Data file 320 Sub Package Definition files 611 are typically comprised of multiple portfolios as shown in Portfolios file 315 of FIG. 6, each with multiple accounts. Each Data Adapter 318 retrieves data from a different Data Source 610. Thus, the Data Consolidator 317 retrieves the Report Section business data 412 of FIG. 7 and combines it into one Sub Package Business Data file 320, in the correct schema.

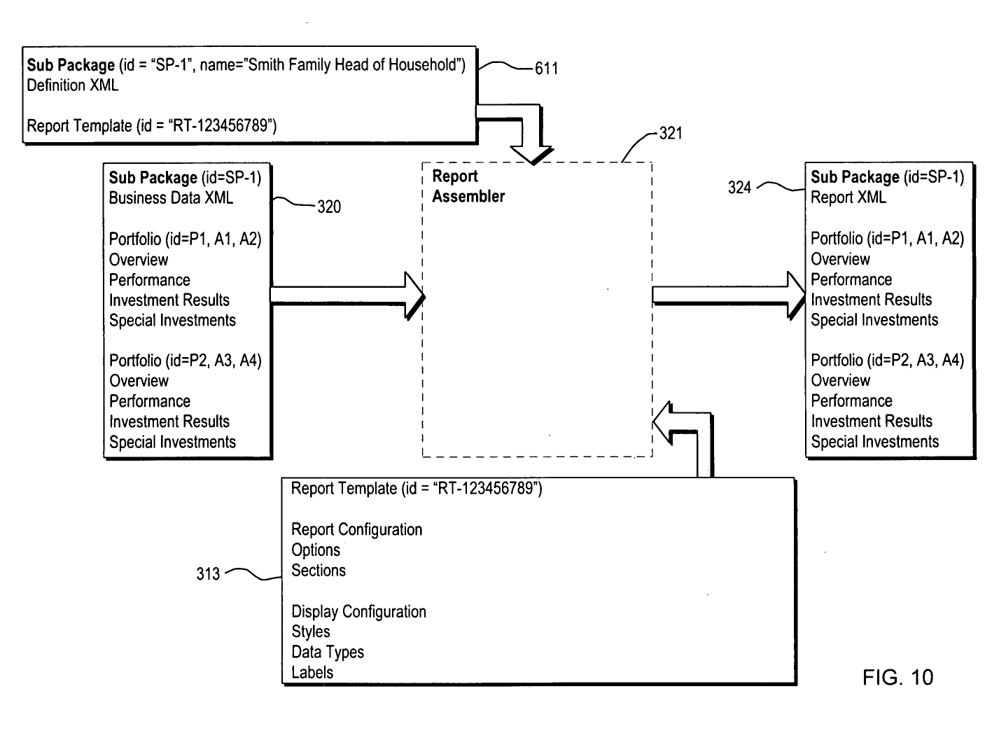

FIG. 10 provides a more detailed illustration of a preferred embodiment of the Report Assembler 321 of FIG. 6. Each Sub Package Definition file 611 is associated with a Report Template file 313, which defines the styles and configuration options for a portfolio report. The Sub Package Business Data file 320 contains the business data necessary to generate all the reports in a sub package. The Report Template file 313 contains the customization information on a portfolio report level, to set report options, as well as report styles, formatting and labels, by way of example. The Sub Package Report file 324 contains both the business data and the configuration and style information necessary to generate all the reports in a sub package.

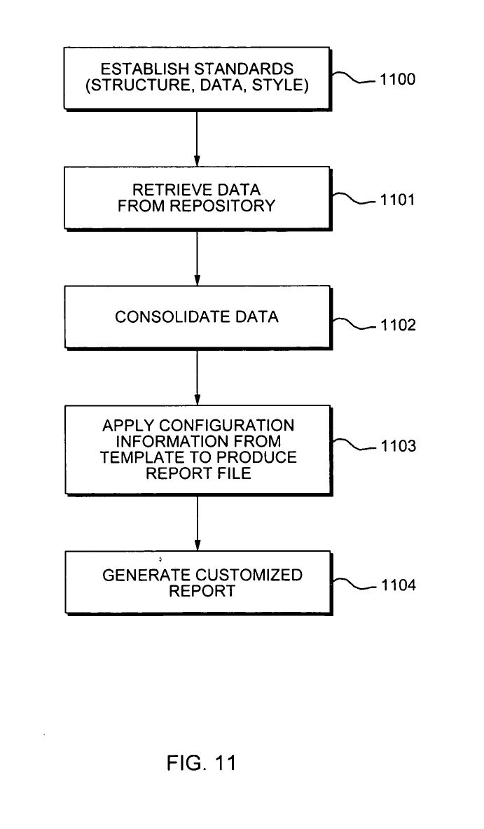

FIG. 11 is a flow chart illustrating a preferred embodiment of a method of the present invention for generating customized reports. One or more standards for describing one or more of a structure of a report, report data and a style of a report are established in step 1100. Data is retrieved from one or more repositories in step 1101. The data is consolidated to form a data file in step 1102 using the standards. Configuration information from a template file is applied to the data file to produce a report file in step 1103. One or more customized reports are generated based on the report file in step 1104. In some embodiments, the report file is rendered to produce one or more reports in one or more of PDF format, HTML format, RTF format, MS Word format or SVG format, by way of example. One or more of the foregoing steps may be performed by software running on a data processing apparatus.

While the invention has been described in detail and with reference to specific embodiments thereof, it will be apparent to one skilled in the art that various changes and modifications can be made therein without departing from the spirit and scope thereof. Thus, it is intended that the present invention cover the modifications and variations of this invention provided they come within the scope of the appended claims and their equivalents.

What is claimed is:

1. A method for generating one or more customized reports, the method comprising:
retrieving data from one or more repositories;
consolidating the data to form a data file;
applying configuration information from a template file to the data file to produce a report file; and
generating one or more customized reports based on the report file.

2. The method of claim 1 further comprising:
rendering the report file to produce one or more reports in one or more of PDF format, HTML format, RTF format, MS Word format and SVG format.

3. The method of claim 1 further comprising:
establishing one or more standards for describing one or more of a structure of a report, report data and a style of a report;
forming the data file using the data and one or more of the standards.

4. A system for generating one or more customized reports, the system comprising:
one or more adapters that retrieve data from one or more repositories;
a consolidator that consolidates the data to form a data file;
a report assembler that applies configuration information from a template file to the data file to produce a report file; and
a report renderer that generates one or more customized reports based on the report file.

5. The system of claim 4 wherein one or more standards for describing one or more of a structure of a report, report data and a style of a report is established, and the data file is formed using the data and one or more of the standards.

6. The system of claim 4 wherein the one or more customized reports are rendered in one or more of PDF format, HTML format, RTF format, MS WORD format, and SVG format.

7. A computer-readable medium comprising instructions which, when executed by a data processing apparatus, perform a method for generating one or more customized reports, the method comprising:
retrieving data from one or more repositories;
consolidating the data to form a data file;
applying configuration information from a template file to the data file to produce a report file; and
generating one or more customized reports based on the report file.

8. The computer-readable medium of claim 6, the method further comprising:
rendering the report file to produce one or more reports in one or more of PDF format, HTML format, RTF format, MS Word format and SVG format.
